(19) United States
(12) Patent Application Publication
(10) Pub. No.: US 2005/0118350 A1
(43) Pub. Date: Jun. 2, 2005

(54) Atmospheric plasma surface treatment method and device for same

(76) Inventors: Pavel Koulik, Blaesheim (FR); Anatolii Saitchenko, Illkirch-Graffenstaden (FR); Svetlana Krapivina, Illkirch-Graffenstaden (FR); Nail Musin, Illkirch-Graffenstaden (FR); Jacques Cinqualbre, Rosheim (FR)

Correspondence Address: Clifford W Browning, Suite 3700, 111 Monument Circle, Indianapolis, IN, 46204-5137, US

(21) Appl. No.: 10/507,805

(22) PCT Filed: Mar. 28, 2003
(86) PCT No.: PCT/IB03/01168

(30) Foreign Application Priority Data
Mar. 28, 2002 (EP) 02405249.0

(51) Int. Cl. H05H 1/00; B05C 5/00

(52) U.S. Cl. 427/535; 219/121.36; 118/620

(57) ABSTRACT

The invention relates to an atmospheric plasma surface treatment method consisting in generating at least two plasma jets using plasma generators, said plasma jets being created by an electric discharge in the flows of gas or input gaseous mixture having an ionisation enthalpy of less than that of the ambient gaseous environment. The inventive method is characterised in that an electric discharge zone, which is disposed between the aforementioned plasma jets acting as electrodes, is non-autonomous and generates a plasma formed mainly by an activated gas which is used to treat the surface, the intensity E of the electrical field creating the discharge that meets the following condition: (JnQ/e)input gas≦E≦(JnQ/e)ambient gas, wherein J is the gas particle activation energy, n is the density of the particles of said gas, Q is the effective section of elastic collisions of electrons with the particles of the gas, and e is the electron charge.

The present invention is concerned with an atmospheric plasma surface treatment method for conductive materials, for poorly conductive materials or for dielectrics, in particular for the activation of their surfaces, and a device for carrying out the method. The invention is particularly well-adapted for the treatment of biological materials, for example for blood cauterisation in surgical operations.

The treatment of the surface of a material can include one or several of the following operations:
surface activation, in particular for improving the adhesion properties or the wettability;
disinfection, sterilisation;
etching;
film deposition;
cauterisation.

Methods and devices are known for the treatment of surfaces by plasma jets at atmospheric pressure (see, for example, the publication: P. Koulik, Dynamical Plasma Operating (DPO) of Solid Surfaces. Plasma Jets, p. 639-653. Solonenko & Fedorchenko (Eds) VSP 1990).

A drawback of these methods is that the plasma of the jet is at a very high temperature (10-15.10³ K) owing to the fact that the interaction of the plasma with the surface to be treated is effected by means of particles (atoms, molecules, radicals) activated in the jet, these particles being generated thermally. The activated particles diffuse through the limit layer in such a manner that they do not loose their activation energy before they impinge upon the surface being treated. This results in important energy losses, in particular of heat, in often undesirable effects of overheating of the surface being treated, and in a low yield of the method. One cannot treat biological tissues (wounds, burns, zones of organs sectioned in surgical operations, etc) by means of a plasma jet which would produce burns and other extensive damage.

Apparatuses for the treatment of living tissues and, in particular, for the cauterisation of zones in which haemorrhages occur in the course of surgical operations are already known (for instance the Erbotom 12C350 apparatus, produced commercially by ERBE médical SARL, Parc d'Affaires, 11 chemin de l'Industrie, 69570, Dardilly, France), which use a high frequency arc operating in a stream of argon, between an electrode held by the surgeon and the tissues of the patient, with the body of the patient being necessarily earthed (unipolar operating mode).

A cauterisation produced exclusively by thermal effects, i.e. by the heat generated as a result of the Joule effect, suffers the drawback that an important volume of tissue through which flows a high density current is damaged during this treatment. Such a method cannot be used for the treatment of zones of high neurological activity, such as the brain, the spine and other nerve centres of importance.

Another problem encountered is that the electric arc is frequently disrupted through contact interruptions and must be each time reinitiated to continue the treatment, owing to the fact that the electric current travels through tissues from which liquid (for example, blood) oozes in more or less important amounts.

In view of the fact that the contact surface of the arc with the treated tissue is determined by the very small diameter of the electrode spots at the plasma—tissue interface, another drawback is that the treatment of large surfaces is difficult, tedious and time-consuming.

The Erbotom ICC350 apparatus makes it possible to carry out a clotting procedure in a bipolar mode of operation, with the electric arc burning between two electrodes being blown towards the biological tissue to be treated by a jet of argon perpendicular to the lines of flow of the current. A drawback here is that the arc deviated by the stream of argon is geometrically unstable and tends to move away from the zone to be treated owing to the fact that the stream of argon does not fully determine the configuration of the arc and does not force the arc to contact against the profile of the surface being treated, thus resulting in a low efficiency. This method does not allow an adjustment of the intensity of the thermal effect of the arc by varying the distance between the electrode and the surface to be treated.

For obvious physical reasons, such a method cannot be used for treating dielectric bodies.

Furthermore, such a method would be of no use for the treatment of metal surfaces, owing to the fact that such surfaces, when grounded, would act as a second electrode. The effect of said arc on the metal would therefore be accompanied by all the degradation phenomena typical of electrodes (occurrence of electrode spots, erosion, fusion, heating, destruction of the atomic structure and others).

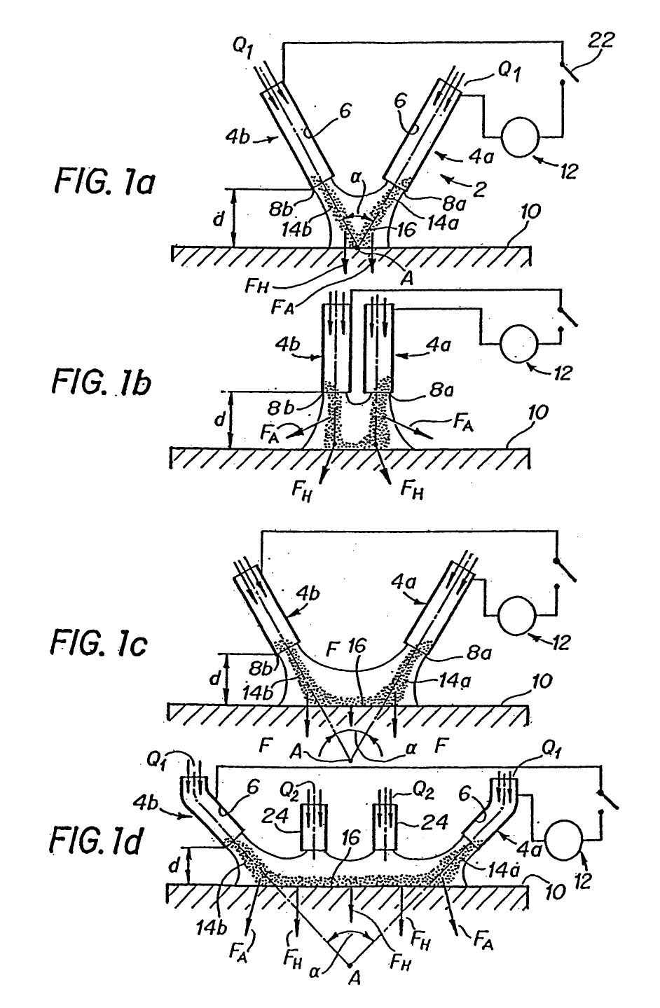

International patent application WO 97/22369 describes a device for carrying out a surface treatment by a plasma and, more particularly, sterilisation. The device of FIG. 1 of this publication includes filament-shaped metal electrodes arranged at a given angle with respect to each other, inside dielectric (quartz) tubes, in which flows a gas. The tubes are open on the side of the electric arc generated between the tips of the filament-shaped electrodes.

The drawbacks of this device are, inter alia:
The heat generated and the electric current associated with the electric arcs are disadvantageous for many applications, such as the treatment of surfaces of biological tissues, in view of the damages caused by the burns generated and by the electric current flowing through the body to be treated. Furthermore, the method is not energy-efficient.
The user is at risk of burning himself with the device.
The flow rate of gas is very high, in view of the need to cool the device under conditions of low temperature gradients.
The quartz tubes undergo destruction as a result of the contact with the electric arcs produced from the electrodes.
The device is difficult to use under conditions in which the material treated, owing to its nature, is liable to obstruct the orifices of the tubes (for example, spluttered blood).
The device is difficult to miniaturise.

In the European patent application EP 0 279 745, there is described a device for the treatment of surfaces with a plasma, similar to the preceding one, but in which the filament-shaped bipolar electrodes are contained in tubular electrode carriers made of metal and acting as conduits for a stream of a fluid which travels through the zone in which is produced an electric arc. The electric arc functions to heat the fluid which flows through it, before impinging upon the surface to be treated. The stream of fluid directs the jet of plasma, cools the electrodes and contributes to the formation of the plasma. The drawbacks of the device described in this publication are, inter alia:
The treatment is exclusively a heat treatment (for example, used for cutting a biological tissue). The result of the treatment is a burn wound, which is more or less deep.
The electric discharge is an arc influenced by the point effects of the filament-shaped electrodes and by the flow of gas, which curb the lines of flow of the current between the ends of the electrodes. A positional accuracy of the treatment is difficult to achieve and is, accordingly, relatively poor.
The fluid used, mainly air and water, has a high ionisation enthalpy which acts on the discharge, mainly to produce heat, which in turn weakens the discharge. Accordingly, the functioning of the apparatus amounts to a competition between the heating of the carrier fluid which cools the discharge and the enhancing action of increased temperature on the electric discharge.
The initiation of such a discharge is consequently difficult and requires special measures for ensuring said initiation. One of these measures includes the provision of electrodes, which are hollow to enable the introduction, for example, of a stream of water or of an aerosol.
The tips of the electrodes are extremely hot and carry the risk of burning both the material being treated and the user.
The device described necessitates a permanent adjustment and a permanent monitoring of the flow rate, as well as of the electric power, and this complicates its utilisation by the user.

An aim of the present invention is to provide a method as well as a device for carrying out the method, for the treatment by an atmospheric plasma of a surface to be treated, which are efficient and avoid or minimise damage of the body to be treated, in particular damage due to excessive heating or to electric current flow through the body to be treated.

Another aim of the invention is to provide a method as well as a device for carrying out the method, for the treatment of the surfaces of biological tissues by an atmospheric plasma, which enable a treatment which is efficient and accurate, while avoiding or minimising burning and damaging of tissue.

It is advantageous to provide a plasma treatment method, which is energy efficient.

It is advantageous to provide an atmospheric plasma surface treatment method, which is reliable and which reduces or avoids the problem of uncontrolled quenching of the plasma.

It is advantageous to provide a device for plasma surface treatment having a simple, compact (in particular for medical applications) and self-regulating design.

It is advantageous to provide a plasma treatment method and device for carrying out this method, enabling the treatment of very large surfaces of materials, in particular for the treatment of burns.

It is also advantageous to provide a plasma treatment method and device for carrying out this method, enabling the treatment of very small surfaces of materials, in particular for use in laparoscopy and in endoscopy.

It is further advantageous to provide a method and a device for carrying out the method, enabling an operation or a combination of operations, such as etching, film deposition, sterilisation, surface activation and various physicochemical and thermal treatments, such as surgical cauterisation, in particular on highly fragile organs, such as the spleen, the liver, the kidneys, the internal genital organs, the heart and the lungs.

Objects of the invention are achieved by a method according to claim 1 or claim 7 and by a device according to claim 10 or 11 for carrying out the method.

Firstly, in the present invention, a method using an atmospheric plasma for the treatment of surfaces of objects or of materials which are conductive or poorly conductive or of dielectric material is organized in such a manner as to feed into the discharge zone a gas or a mixture of gases (carrier gas) having an ionisation enthalpy less than that of the ambient gas (for example, air). In other words, the generation of an electric discharge in the carrier gas (or in the mixture of carrier gases) requires an amount of energy lower than that required for an electric discharge in the ambient gas. This first condition determines the apparition and the maintenance of the discharge and thus of the plasma in the stream of the carrier gas. The configuration of this stream, in this case, determines the configuration of the plasma, i.e. of the ionised state of the carrier gas and hence the geometrical shape of the discharge. This is a condition of stabilisation of the electric discharge. It makes it possible to localize the plasma within the stream of the carrier gas and compel the same to follow the path of the stream and not that of the shortest distance between the electrodes slightly modified by hydrodynamic effects, and, in particular, to exit from the tubular electrodes and impinge upon the material to be treated and to adapt to its contour, as does the stream of the carrier gas. However, the plasma is produced by the electric current of the discharge and, accordingly, the electrons will, later or sooner, make their way to the electrodes. Accordingly, there will be, at this time, a competition between the flow of the carrier gas and the electro-dynamic forces. The result of this competition determines the final configuration of the plasma.

Secondly, the effective cross-section of elastic electron—atom interactions of the carrier gas is smaller than the effective cross-section of elastic electron—atom interactions of the ambient gas (air for example). This second condition implies that the electrons of the plasma (the plasma needs to be only weakly ionised for the discharge to exist) must have a mean displacement relative to the atoms which is sufficiently large to accumulate a high kinetic energy in the electric field of the discharge. This energy can reach the activation energy of the atoms of the carrier gas or of the particles introduced into the plasma upstream of the electrodes, thus activating chemically these particles, putting the plasma out of the state of thermodynamic equilibrium. From this moment, any interaction of the particles of the plasma with those of the materials treated, in particular their activation, becomes a so-called plasmo-chemical interaction, which is much more effective and rapid than the essentially chemical or thermal interactions of the prior art.

Thirdly, a necessary condition for the plasma to achieve a state of non-thermal excitation is: E>JnQ/e

where: E is the intensity of the electric field creating the electric discharge

J is the energy of activation of the gas particles
n is the density of the particles of the gas
Q is the effective section of the elastic collisions of the electrons with the particles of the gas
e is the charge of an electron.

According to the invention, the intensity of the electric field E is adjusted in such a manner as to satisfy the following condition:
(JnQ/e) carrier gas<E<(JnQ/e) ambient gas

The behaviour of the discharge will also be determined by the flow rate of the plasma in the two columns. There are two limit flow rates. The first one, G₁, is a low flow rate at which the discharge has the shape of an arc between the two carrier gas tubes. This operating condition can easily be detected, since an arc becomes apparent between the two electrodes (tubes). The temperature therein can reach ˜6000-7000° C. This operating condition corresponds to the state-of-the-art.

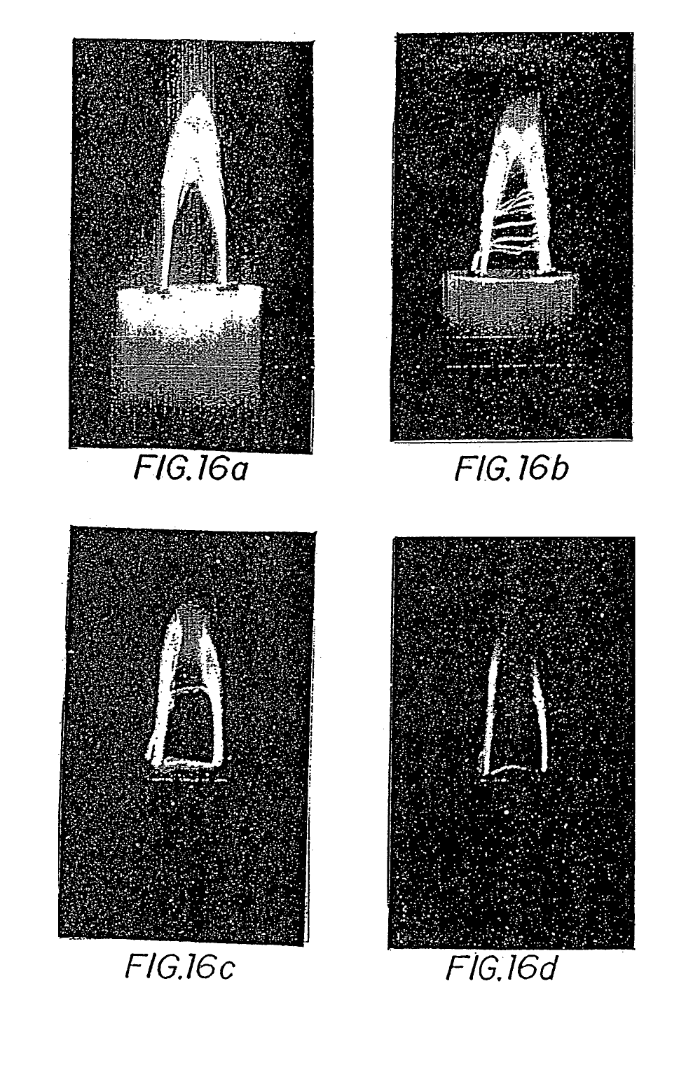

When the flow rate of the carrier gas supplied to the discharge is increased, the arc stretches and subsequently disappears. Two columns or jets remain, between which there is a non-autonomous discharge. It is termed as being “non-autonomous” because it cannot exist without the zone between the columns being supplied with ions and electrons (plasma) emitted from these columns. These two plasma columns function as electrodes. However, these electrodes are specific: one is a metal electrode, shaped, for example, as a spike and emitting only electrons. The electrode in the form of a plasma column emits electrons, but also ions (of the plasma) through convection and photo-ionisation. This plasma electrode is therefore highly specific and differs from the metal electrodes as they are known in the state-of-the-art techniques. The main effect, which is put to use in the present invention is the convection effect, caused by the flow of plasma in the plasma electrodes (plasma jets, columns). The higher the flow rate of the gas in the plasma jets is, the higher the voltage across the plasma electrodes must be, in order to maintain the discharge. At a certain flow rate, breakdown discharges appear between the electrodes (see more particularly the breakdown filaments in FIG. 16b).

There is a maximum flow rate G₂ at which the plasma columns are not capable any more of creating, by convection, an ionised medium (plasma) sufficiently conductive for maintaining the discharge. The current stops, the discharge disappears (and also the plasma jet electrodes). This limit flow rate is obviously detected visually. Accordingly, the flow rate G of the gas (which is most often identical in the two plasma electrodes) which makes it possible to achieve the discharge conditions claimed must necessarily be between the two following limits:
G₁≦G≦G₂
This condition can be the best met by sending between the plasma electrodes an additional gas stream via one/several nozzles (or tubes) of which the axis/axes is/are in the plane of the axes of the plasma electrodes while being positioned symmetrically relative to these electrodes. In this case, if G* is the flow rate of the additional gas, one has the following condition to satisfy the requirements of the present invention:
G₁*≦G*≦G₂*
in which G₁* is the value of G* beneath which a conventional arc occurs between the tubes/electrodes and G₂* is the maximum flow rate above which the discharge is blown out, i.e. does not exist any more.

The additional gas can be of a different chemical nature from that of the carrier gas of the electrodes and that of the ambient gas (for example: CO₂, N₂, O₂, NH₃, vapours of organo-metallic compounds, and similar, or their mixtures).

The non-autonomous discharge makes it possible to provide on the surface to be treated particles (atoms, molecules, radicals), which are highly activated and which determine the surface treatment applied, such as cauterisation of wounds, disinfection, surface activation before the deposition of a film, dyeing, surface etching, film deposition, and creation of surface alloys.

Experience has shown that this method and the corresponding device make it possible to carry out surface treatments by means of the jet of activated particles emitted from the device of the invention, at a low temperature (T˜30-40° C.) of the surface to be treated. One can thus treat heat-sensitive materials. The treatment is the result of a plasmo-chemical reaction on the surface and not of a thermal effect at the location where the arc comes in contact with the surface, as is the case in conventional techniques. The plasma created between the electrodes is clearly a plasma which is shifted away from its state of thermodynamic equilibrium and in which the concentration of the activated particles (atoms, molecules, radicals) is particularly high, without however the temperature of the plasma being high and this in particular at the ambient pressure.

In summary, the implementation of the measures described above makes it possible to avoid or to strongly reduce the formation of a thermal plasma, such as that generated by autonomous electric arcs and to optimise the formation of activated atoms or molecules in the treatment zone. This makes it possible to carry out plasmo-chemical treatments on the surface to be treated (for example, a surface activation, a plasmo-chemical etching, a deposition of a film in conditions shifted away from those of a chemical equilibrium and others) with a plasma at a low temperature, having low energy requirements and needing only a relatively low electric current, but rich in atoms, molecules and radicals activated to optimise the desired plasmo-chemical reactions.

The device can include two electrodes or more, provided as metal tubes of a small diameter by means of which the carrier gas is introduced into the discharge zone. The electrodes are directed one towards the other at an angle in the range from 0 to 180° and are inserted in an insulating body which holds them one relative to the other.

The insulating body of the tubular electrodes can include an additional channel through which travels the carrier gas the composition of which is determined by the requirements of the treatment. The device can be inserted in a metal or in a plastic body, into which penetrate electric wires and the tubes ensuring the gas supply. The operative end of the device can be protected by a sheath made of plastic or of ceramic. The electrodes are connected to a power source producing a direct current, an alternating current (high frequency or three-phase) or a pulsed current.

The electric current travelling from one electrode to the other follows first the gas channel formed by the gas exiting from the tubular electrodes, the gas having an ionisation potential and energy which are lower respectively than the ionisation potential and energy (enthalpy) of the ambient gas (typically air). Thereafter, the current is divided into the two plasma jets formed (see FIGS. 16a to 16d). As the voltage difference between the electrodes increases, breakdown channels can appear between the two plasma jets functioning as electrodes.

It is possible, depending on the requirements of the treatment, to obtain an arrangement of the electrodes enabling a more or less broad zone to be swept by the stream of plasma urged by the stabilising gas against the surface of the material treated. In an embodiment of the method, one can, for example, carry out very local treatments, when the zone to be treated is located in the vicinity of the point of intersection A of the axes of the two electrodes (see FIG. 1a).

In another embodiment, one can carry out a locally restricted treatment through very small orifices, such as in coelioscopy or in endoscopy, when the tubular electrodes are parallel to each other, with the stabilising gas and Ampere's forces preventing any short circuit from occurring between the electrodes and urging the same to flow in such a manner as to come in contact with the material to be treated (see FIG. 1b).

Conversely, in another embodiment, one can carry out the treatments on a broad zone by sweeping the same by the column of the stabilised arc urged both by the hydrodynamic forces (F_{H}) and by Ampere's forces (F_{A}) against the surface to be treated, with the tubular electrodes being, in this case, widely apart from one another and the intersection point A of their axes being geometrically beneath the surface to be treated (see FIG. 1b).

In yet another variant, in order to further broaden the zone to be treated, one can place the tubular electrodes even more apart from one another than in the previous case, while adding intermediate tubes in the plane of the tubular/substantially tubular electrodes, directed towards the surface to be treated, with additional gas jets being emitted from these intermediate tubes and the ionisation potential and energy (enthalpy) of the additional gas being lower than those of the ambient gas, so as to hold, through hydrodynamic forces, the plasma channel in contact with the surface to be treated at a large distance from the electrodes, there where Ampere's forces do not suffice to this end. Instead of intermediate tubes, one can use a tube, which is flattened in the plane of the electrodes, in such a manner as to urge uniformly the plasma against the surface to be treated.

The method according to the invention makes it possible to treat dielectric materials. The electric current does not penetrate to any large extent inside materials of a low conductivity, such as biological tissues, for example, during surgical operations. The treatment of metal materials is also possible. In this case, a portion of the current travels superficially through the metal. Experience shows that actually, in the case of a cooled metal, this portion of the current is small, because the metal surface is covered with a thin layer of cold gas which is non conductive and which prevents a short-circuit via the metal.

The configuration of the plasma as converging jets makes it possible to introduce the carrier gases into the plasma in an effective manner, by using the zones of the boundary layers surrounding the plasma and by creating hydrodynamic flows, which are, most of the time, turbulent in nature. The method proposed enables an easy control, either via the current source, or via the flow rate of the carrier gases and/or by varying the geometry and the distance of the electrodes from the material treated.

In another embodiment designed for the treatment of broad surfaces, for example of burns on biological tissues, it is possible to use several electrode assemblies arranged as a comb, in such a manner as to sweep simultaneously a broad surface of the body to be treated.

Other objects and advantageous features of the invention will become apparent from the claims, from the description of embodiments of the invention made hereafter, and from the annexed drawings, in which:

FIGS. 1a to 1d are simplified cross-sectional views, illustrating the construction of the tubular electrodes according to different embodiments of the invention;

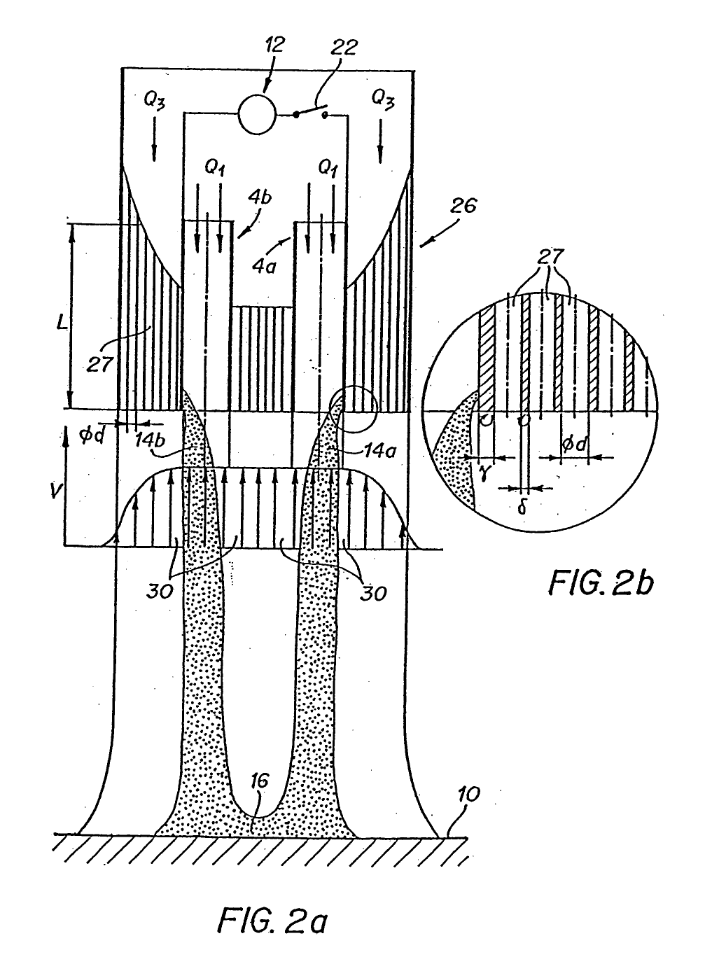

FIG. 2 is a simplified cross-sectional view illustrating the tubular electrodes in a hydrodynamic filter for conferring a laminar flow to the gas stream, according to one embodiment of the invention;

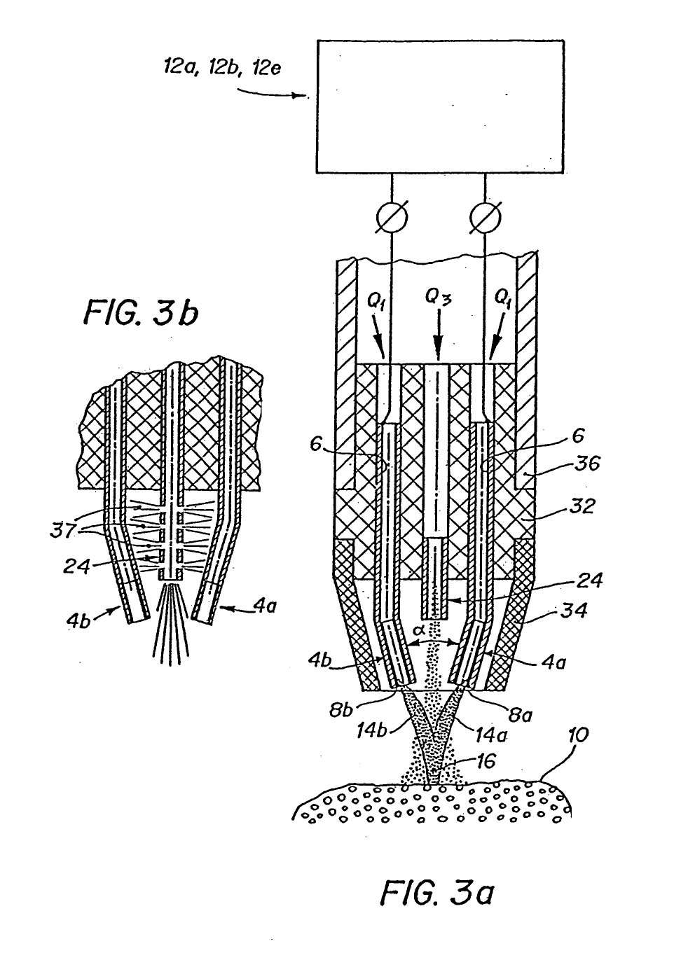

FIG. 3a is a cross-sectional view of a part of a surface treatment device according to an embodiment including two tubular electrodes;

FIG. 3b is a detailed cross-sectional view of a part of the device of FIG. 3a;

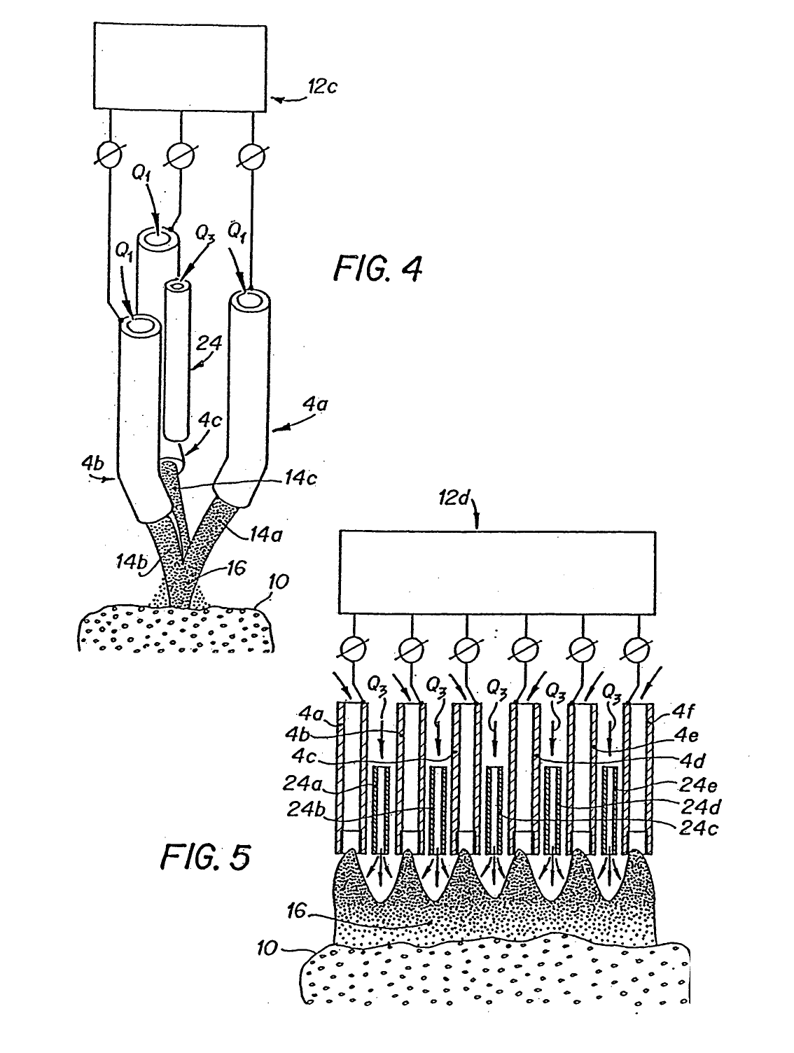

FIG. 4 is a perspective view of a part of a device according to another embodiment with three tubular electrodes being used for generating a three-jet discharge and with a central intermediate tube for feeding an additional gas;

FIG. 5 is cross-sectional view of a device according to another embodiment, constructed as a comb for the treatment of broad surfaces;

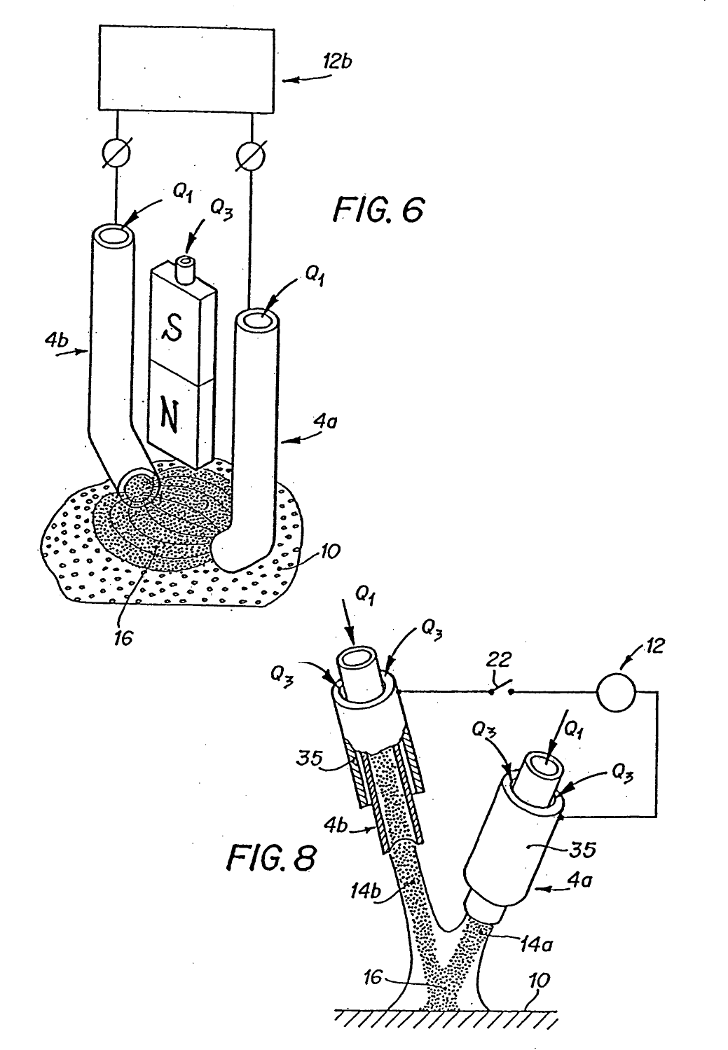

FIG. 6 is a perspective view of a part of a device, illustrating the distribution of the current lines in the case of a discharge flattened by the action of an additional magnetic field;

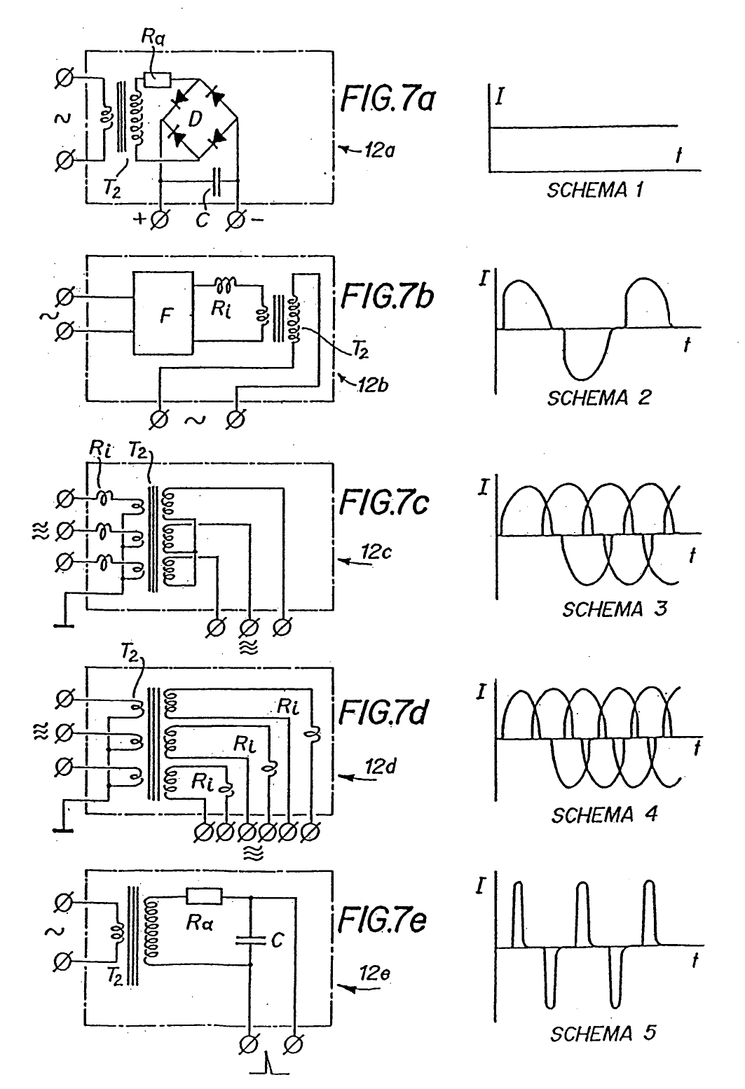

FIGS. 7a to 7e are schematic illustrations of different manners of power supplying devices for the treatment of surfaces with an atmospheric plasma, according to the invention;

FIG. 8 is a perspective view of a device according to another embodiment;

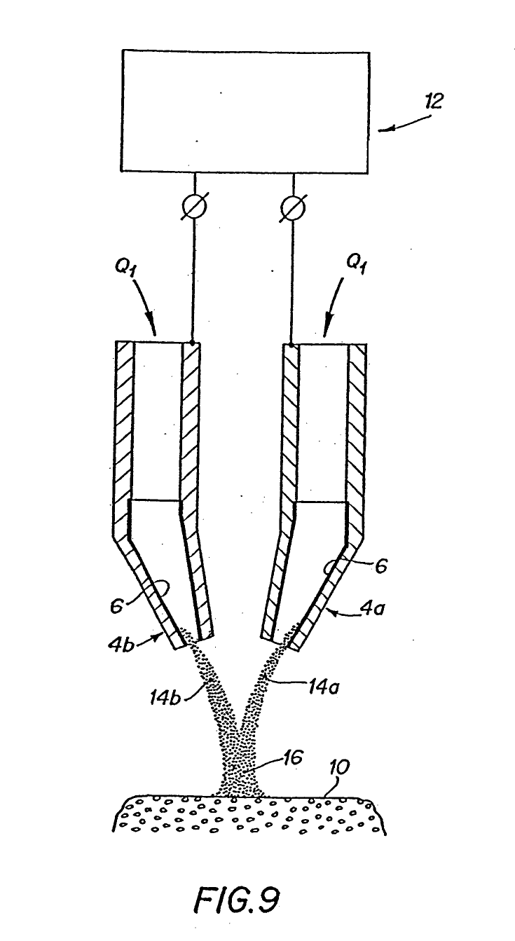

FIG. 9 is a perspective view of a part of a device according to the invention illustrating the case where the device is power supplied by means of high-frequency current pulses and where the discharge parameters are adjustable;

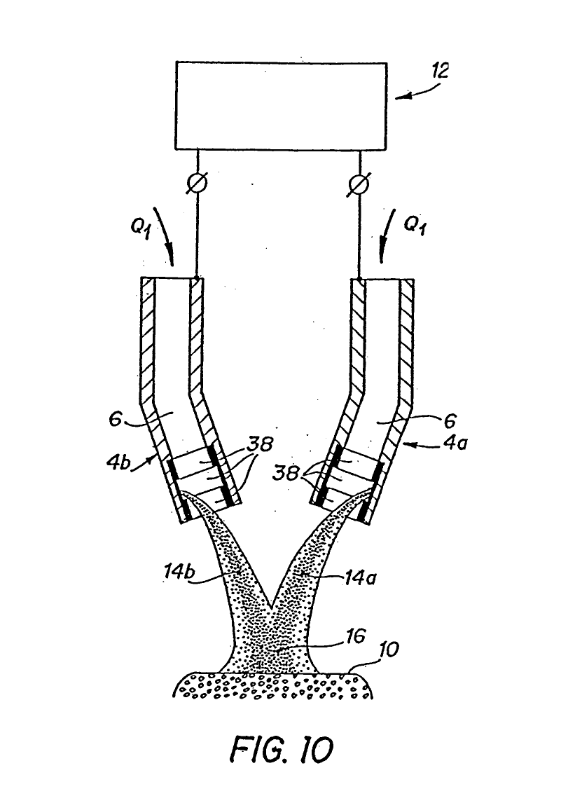

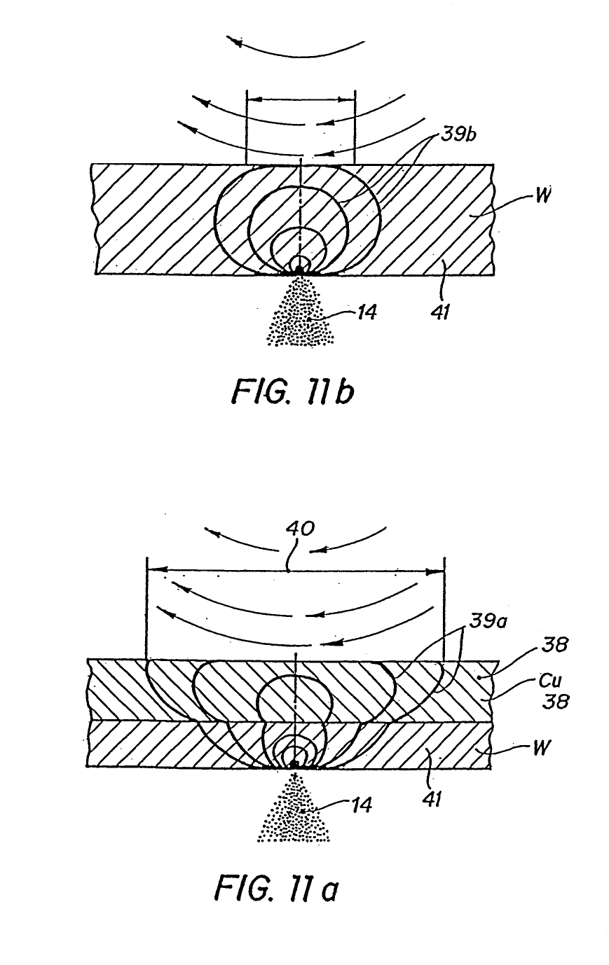

FIG. 10 is a cross-sectional view of a device according to another embodiment, in which the tubular electrodes are provided with rings having a high thermal conductivity;

FIGS. 11a and 11b are simplified cross-sectional views of parts of the electrode walls, respectively with and without rings;

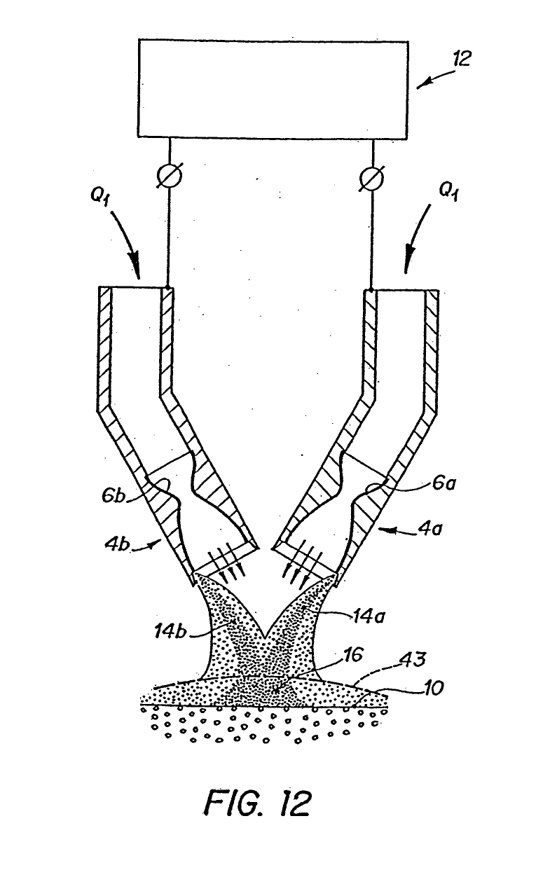

FIG. 12 is a cross-sectional view of a device according to another embodiment, in which the tubular electrodes have a flow channel constructed as a Laval nozzle;

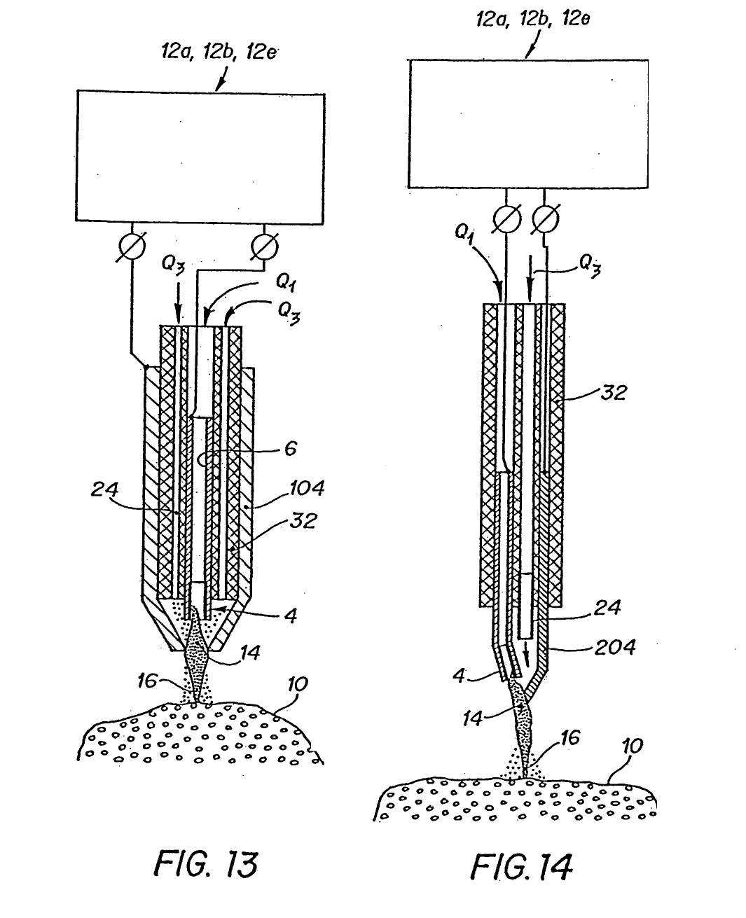

FIG. 13 is a cross-sectional view of a device according to another embodiment, adapted in particular for clotting blood and for sterilising purposes, with an inner electrode and an outer electrode having the shape of a cone and the two electrodes being co-axial;

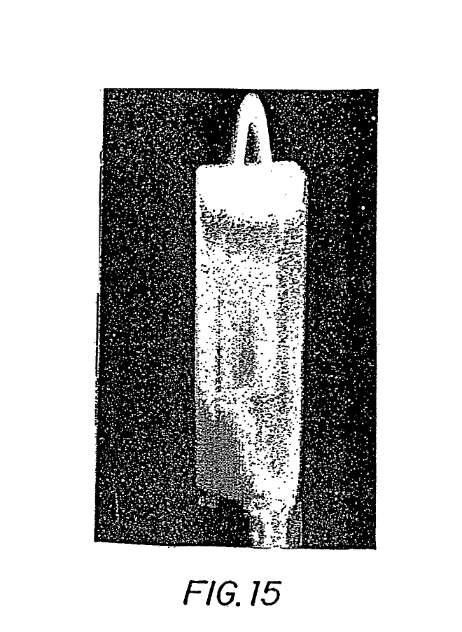

FIG. 14 is a cross-sectional view of a device according to another embodiment with a monolithic electrode and a tubular electrode;

FIG. 15 is a photograph of a device according to the invention showing the formation of a plasma;

FIGS. 16a to 16d are photographs of a device according to the invention illustrating different shapes that the discharge between tubular electrodes can assume and in particular the formation of a non-autonomous plasma between two plasma jets, functioning as plasma electrodes;

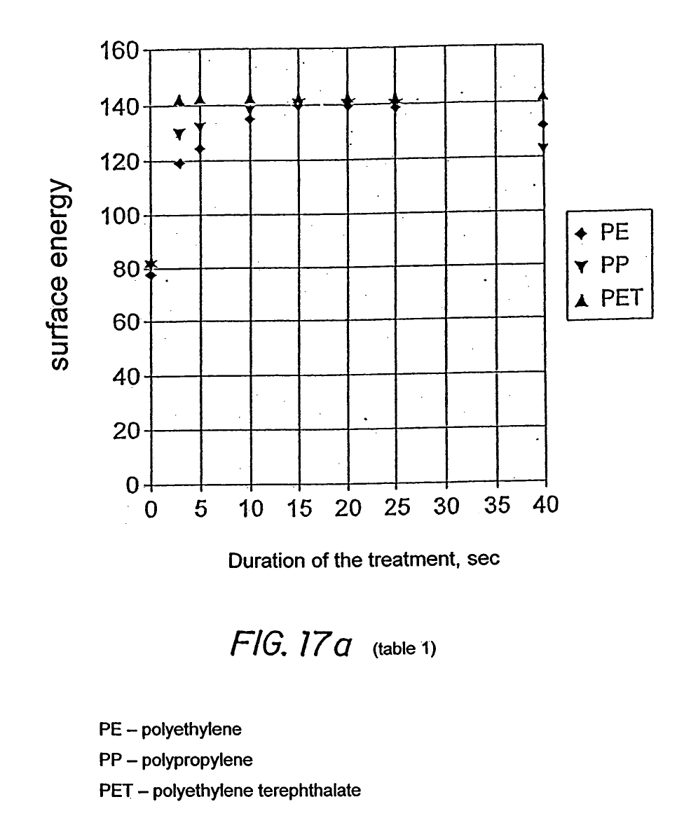

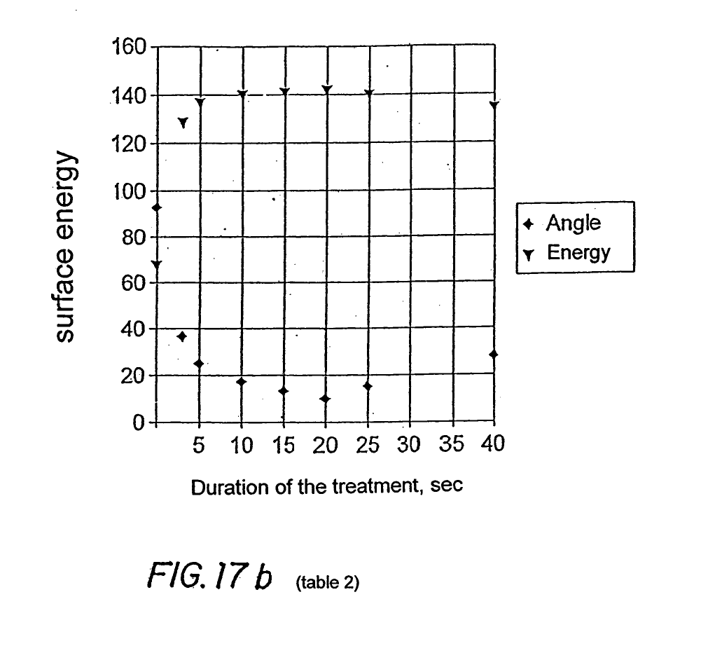

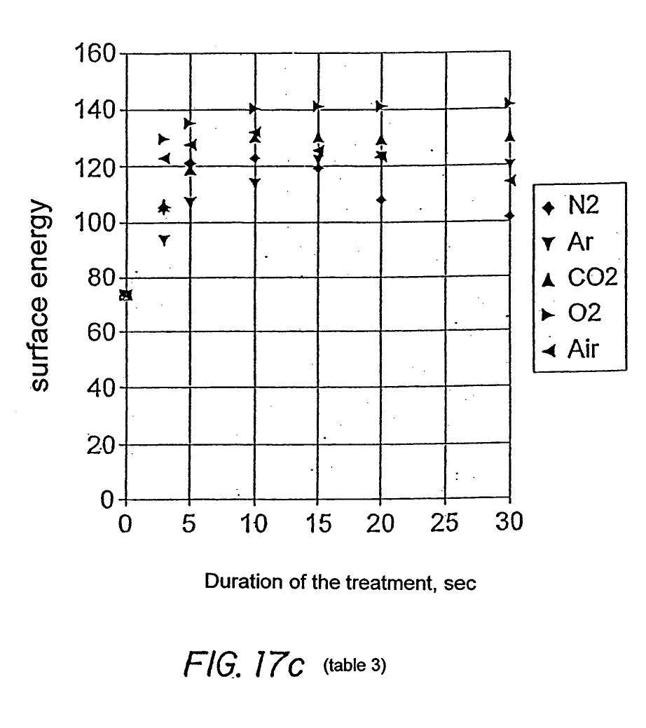

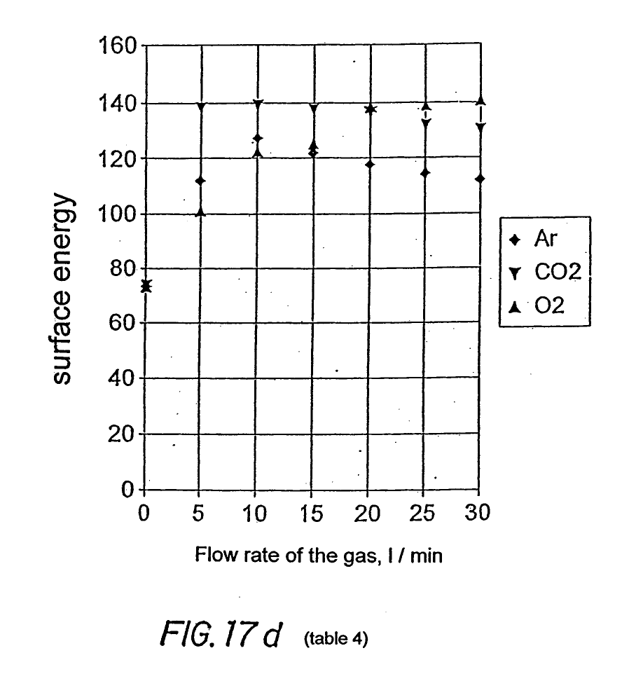

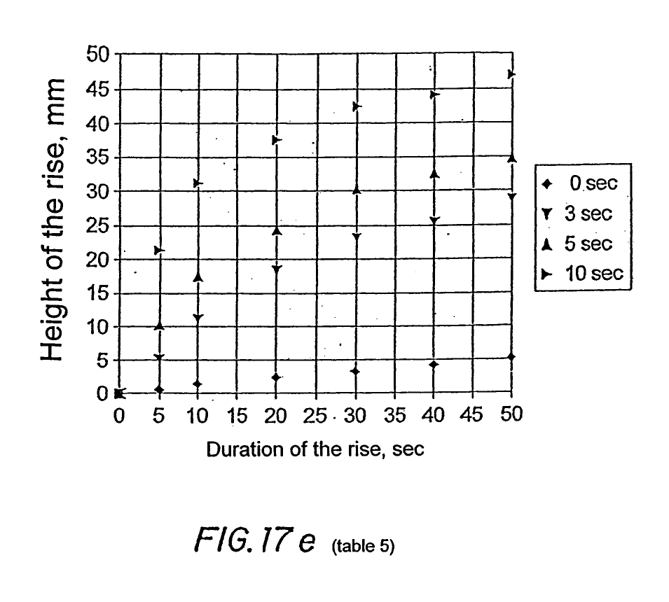

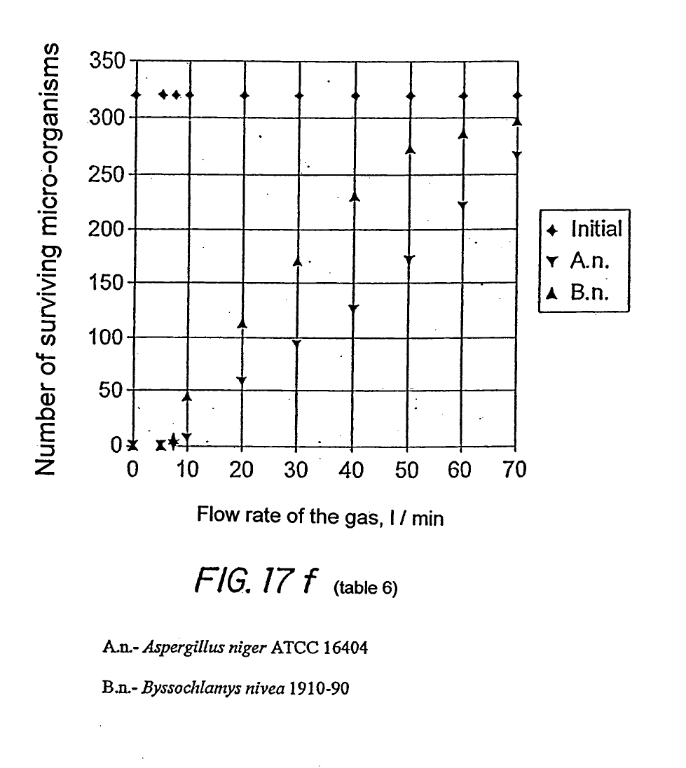

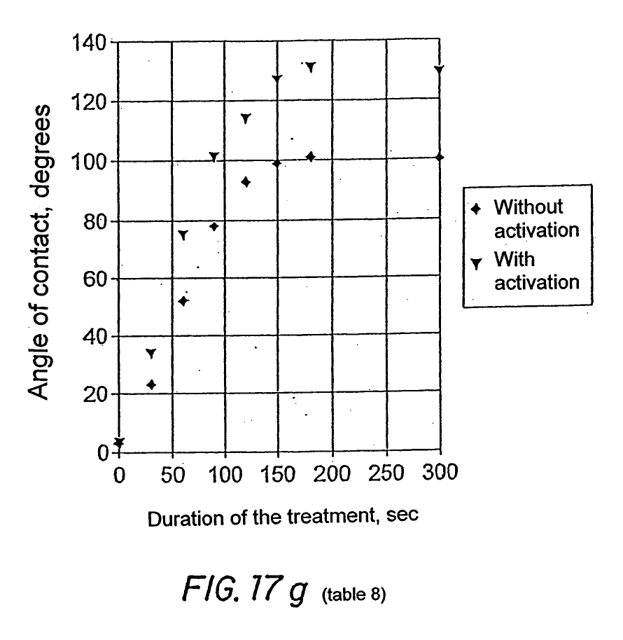

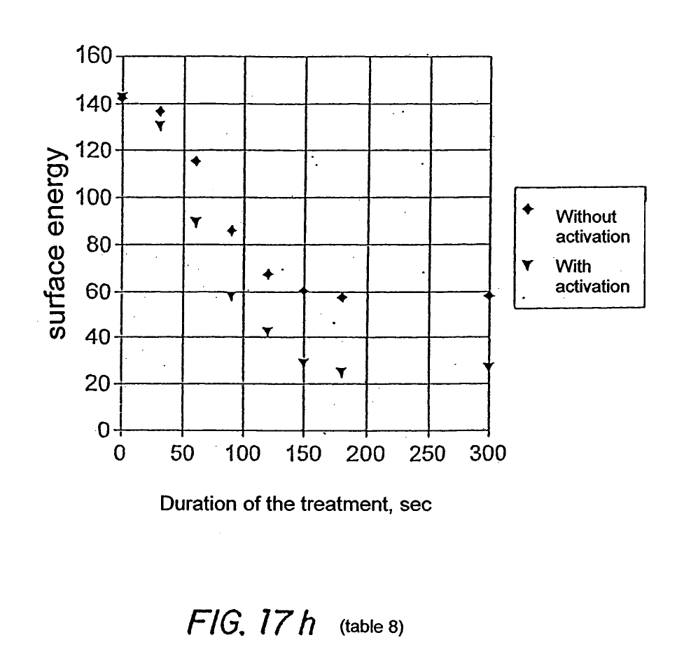

FIGS. 17a to 17f illustrate graphically the results, respectively, of tables 1 to 6 obtained in the examples 1 to 6 hereafter and the FIGS. 17g ad 17h illustrate graphically the results of the table 8 obtained in the example 7 hereafter.

FIGS. 1a to 1d show, in a simplified manner, the main elements of a device for carrying out a surface treatment by an atmospheric plasma, according to the invention. The device includes a system of tubular electrodes 2 comprising at least two tubular electrodes 4a, 4b supplied with a carrier gas Q₁ flowing via the central channels 6 of the electrodes. In the embodiment of FIGS. 1a, 1c, 1d, the axes A₁, A₂ of the electrodes are arranged one with respect to the other at an angle α and they intersect at a point A. The ends 8a, 8b of the electrodes are positioned at a distance d from a surface to be treated 10, having any type of contour. The tubular electrodes 4a, 4b are connected to a power supply circuit 12 having a wiring diagram such as illustrated in one of the FIGS. 9a to 9e.

The electric discharge generates, from each tubular electrode, a plasma jet 14a, 14b which functions as an extension of the tubular electrode, and hence an electrode. The parameters of the electric power supplied to the electrodes are adjusted depending on the parameters of the stream of the carrier gas Q₁ (properties, flow rate) in order to obtain, in a treatment zone 16, a non-autonomous plasma comprised essentially of an activated gas. The choice of the carrier gas and the control of the parameters of the flow rate of the carrier gas and of the intensity of the electric field, made taking into account the characteristics of the ambient gas 18 (which is generally air, but which can be, in coelioscopy CO₂) make it possible to avoid or to strongly reduce the occurrence of a thermal plasma in the treatment zone between the electrodes and to optimise the use of the power for the generation of the activated gas required for the plasmo-chemical reactions on the surface to be treated. This also makes it possible to reduce the electrical current, thus reducing the problems associated with the flow of an electric current in the object to be treated. The carrier gas has an ionisation enthalpy lower than that of the ambient gaseous medium (which would generally be air). The carrier gas can also be a rare gas (such as argon) or a gas mixture (for example, including NH₃, O₂, N₂, CO₂, vapours of organo-metallic compounds, freons, etc, and their mixtures), selected depending on the plasmo-chemical reactions desired and on the type of treatment to be carried out (sterilisation, deposition, etc.).

The plasma discharge generated at atmospheric pressure between the ends of the electrodes is contacted with the surface to be treated, by the action of hydrodynamic forces F_{H} and of Ampere's forces resulting from the passage of current in the zones coaxial with the electrodes and by the action of the magnetic field created by this current, in a direction perpendicular to the direction of the current in the contact zone 20 of the plasma column with the surface to be treated.

The source 12 of current supply, which is equipped with a switch 22, can be a source of a low voltage or of a high voltage direct current or alternating current (unipolar, bipolar, pulsed, high frequency), depending on the application.

FIG. 1a illustrates the case in which a locally restricted treatment is carried out by adjusting the distance d between the ends of the electrodes and the surface to be treated in such a manner that the intersection point A of the axes A₁, A₂ of the tubular electrodes be on the surface 10 to be treated. This treatment corresponds to a maximum concentration of energy (i.e. maximum energy density) on a treatment zone with a minimal surface area.

The device according to FIG. 1b makes it possible to obtain locally an energy density, slightly lower than in the case of FIG. 1a. Here, the tubular electrodes run parallel to each other. The behaviour of the streams of plasma emitted from the electrodes is basically the result of the competition between Ampere's forces F_{A} between the two columns of plasma in which the electric currents are anti-parallel, these forces urging away from each other the two jets of plasma and the hydrodynamic forces F_{H} resisting to this repulsion. The junction of the lines of current occurs along the surface to be treated. The advantage of this version is that the tubular electrodes 4a, 4b can have a very small diameter. Accordingly, one can use it for medical applications, such as the clotting of blood, in coelioscopy and in endoscopy.

The arrangement of the electrodes of FIG. 1c corresponds to the case in which a broad treatment zone is needed. The electrodes are spaced apart form each other, with the point of intersection of their axes A being beneath the surface to be treated. The plasma treatment zone 16 is urged against the surface to be treated 10 by the effect of the hydrodynamic forces F_{H} and of Ampere's forces F_{A}. This arrangement can be used, for example, for the treatment of burns.

When it is necessary to treat even broader zones, one can use the arrangement illustrated in FIG. 1d. It differs from that of FIG. 1c in that, to facilitate the passage of the current along the surface to be treated 10 and to urge the plasma 16 against the surface to be treated 10 over the width of the zone to be treated, support gas streams Q₂ are provided, either by means of support gas supply tubes or channels 24, for example perpendicular to the surface, or by means of a flattened support gas nozzle issuing a stream of support gas Q₂ in the shape of a curtain substantially perpendicular to the surface to be treated 10. This support gas Q₂ can de identical to or different from the carrier gas Q₁, depending on the treatments to be carried out.

In the case of FIGS. 1c and 1d, the treatment of a broad surface is achieved by a sweeping motion over the surface to be treated in a direction perpendicular to the direction of the current I generating the plasma along the surface.

Another mode of carrying out the method claimed consists in inserting the tubular electrodes into a device producing a laminar flow, for example, a hydrodynamic filter 26 having a multitude of small longitudinal channels 27 forming a honeycomb-like arrangement, in such a manner as to include the zone of formation of the stream of plasma within a stream of gas with a laminar flow (such as illustrated in FIGS. 2a and 2b). To this end, the conditions for the characteristic dimensions of the device satisfy the following conditions:
Re_{local}=ρₗₐₘvδ/μₗₐₘ˜ρₗₐₘvγ/μₗₐₘ˜ρ_{add}vγ/μ_{add}<10³
in which ρ an v are, respectively, the density and the velocity of the gases, δ and γ are characteristic dimensions (see FIGS. 2a and 2b), μ is the viscosity of the gas and Re is the Reynolds number. The indices “lam” and “add” relate, respectively, to the laminar gas flow and the support gas. In this embodiment, localised instabilities (turbulences) are absorbed by the surrounding medium and do not develop, keeping flow laminar.

The hydrodynamic filter 26 can be designed as a plurality of tubes 27 of a small diameter d having walls with a very small thickness (δ<<d), the length L of these tubes varying in such a manner as to minimise or annul the gradient of the velocity v of the gas in the interface zone 30 between the tubular electrodes and the ambient air. An additional gas Q₃ different from the carrier gas Q₁ feeding the electrodes 4a, 4b (argon for example) can be used to this end.

The advantages of this version are, inter alia:
The stream of plasma is made laminar even when the Reynolds number is greater than 10³, the interactions (thermal, hydrodynamic and compositional) are of a molecular and of a non convective nature and, accordingly, they are of a much smaller amplitude. The corresponding losses are strongly reduced;
The conversion of the flow to a laminar one makes it possible to transport the plasma without any loss of activation energy over a greater distance. In other worlds, the length of the plasma jet can be much greater than that of the plasma jet without the device for making the flow laminar;
The stream of gas with a laminar flow surrounding the plasma can, at the same time, protect the same from any contamination arising from the ambient air, from oxygen from the air, from dust and from various micro-organisms. Accordingly, a device of this type can be used not only for cauterising bleeding wounds, surgical cuts and burns, but also to achieve a sterilisation of a locally restricted or of a broad surface.

Another variant of the method claimed consists in connecting the tubular electrodes to a source of high frequency current and in generating the plasma inside tubes made of a dielectric material and coaxial with respect to the electrodes, as is illustrated in FIGS. 3a and 3b. The advantage of this version is that the plasma is generated uniformly within dielectric tubes. It is not contaminated by the material of the electrodes due to a localised heating in the contact zones of the discharge with the electrodes, as is the case when a unipolar supply current is used. Furthermore, the plasma is well out of its state of thermodynamic equilibrium, which makes it possible to carry out surface activation treatments.

FIG. 3 shows a device for carrying out a surface treatment with plasma comprising two tubular electrodes 4a, 4b mounted inside a dielectric body 32. The ends 8a, 8b of the electrodes are curved in such a manner as to form an angle α therebetween, the angle α being in the range from 0° to 180°, advantageously from 20° to 40° and preferably of about 30°. The electrodes are provided as narrow tubes, having a diameter, for example, of 1 to 3 mm and thin walls (in the order of one tenth of the diameter of the tube) made of a metal exhibiting a high thermal conductivity and a high chemical stability (for example copper, silver, brass). A carrier gas Q₁ with a low ionisation energy (for example xenon) is introduced into the central channels 6 of the tubular electrodes. An electric discharge provided for by the current supply circuit 12 is generated in the stream of the carrier gas Q₁ and forms two plasma jets 14, 14b emitted from the tubular electrodes. Additional gas Q₃, which is different from the carrier gas, can be introduced into the discharge zone via a nozzle 24 located between the electrodes 4a, 4b. This additional gas can be oxygen, nitrogen, carbon dioxide, and similar, or one of their mixtures. The choice of the composition of this gas and of its flow rate depends on the requirements of the application. The central nozzle can have radial perforations 37 for ensuring that the flow of the additional gas between the electrodes occurs radially and in the direction of the plasma jets.

A protective wall 34 surrounding the electrodes and extending beyond the ends 8a, 8b of the electrodes, prevents any accidental burns which otherwise could arise from a contact of the surface or of the body to be treated with the hot tubular electrodes.

The device is operated by moving the body 36 of the device, which is supplied via flexible tubes with gas and with current (not illustrated in the figure).

The electrodes constructed as tubes of a small diameter inside which flows the carrier gas confer, inter alia, the following advantages:
The electrodes can be brought very close to each other, which makes it possible to miniaturise the device.

Owing to the small cross-sectional surface of the tubular electrodes, the flow of heat in the direction of the dielectric body is low. The different parts of the device remain cold during operation, even under stationary operating conditions.

The flow rate of the carrier gas is sufficient to cool the ends of the electrodes. Cooling with water is not necessary. The device operates as a self-cooling device, which ensures an efficient use of the input energy.

Experience has shown that the device operates reliably at low flow rates of the gas and that its potential field of applications is practically unlimited.

The flow of the gas from the nozzle 24 between the plasma jets 14a, 14b meeting under an acute angle α, ensures a natural supply of the gas to the treatment zone 16, an efficient heating thereof, and the activation, the dissociation and the ionisation of its particles.

A broad range of treatments is possible, depending on the composition of the plasma and on the level of heating and of activation of the plasma. The control of the operational and of the treatment parameters is achieved via the flow rate of the gas, the type of discharge, the magnitude of the current and its voltage, as well as the geometry of the arrangement. It is possible to carry out, if needed, an additional cooling of the electrodes by the carrier gas.

FIG. 4 illustrates a device for implementing the invention in which there are three tubular electrodes 4a, 4b, 4c, positioned symmetrically about an intermediate nozzle 24 emitting an intermediate gas Q₃. This device makes it possible to generate a plasma using a three-phase current. The tubular electrodes slant inwardly, i.e. in the direction of the central axis of the device. The plasma is emitted as three jets 14a, 14b, 14c converging on a discharge treatment zone 16. Such a discharge makes it possible to focus onto a geometrically restricted zone, an electric energy which is high by comparison with the case of a single-phase power supply, and is less likely to extinguish when contacting the surface to be treated. The flow rate of the carrier gas Q₁ can be very high.

FIG. 5 shows an embodiment of the device arranged as a comb or a brush with more than two tubular electrodes 4a, 4b, 4c, 4d, 4e, 4f which are supplied with a carrier gas Q₁ and intermediate nozzles 24a, 24b, 24c, 24d, 24e, 24f which are supplied with an additional gas Q₃ and which are arranged parallelly with respect to one another, for the treatment of broad surfaces, for example of biological tissues, for example for the treatment of burn surfaces. In this case, it is possible to carry out the treatment in two steps, the first being aimed at stopping effusion (oozing) and at drying the surface to be treated and the second at depositing a film of a neutral composition, such as an oxide and, more particularly, silicon oxide or an organic film, such as a polyethylene, functioning as a crust which obstructs the lymphatic micro-vessels and protects the damaged surface from infection and contamination. The additional gas Q₃ can be different from the carrier gas Q₁ and, depending on the treatment to be carried out, it can include a gas mixture capable of the desired plasmo-chemical reactions (for example hexamethyldisilazane for depositing a film of silicon oxide, etc).

In the embodiment of FIG. 5, owing to the small diameter of the tubular electrodes and which amounts, preferably, to less than 3 mm, it is possible to produce the electric discharge at the angle α =0, to bring the electrodes very close together and accordingly to carry out a uniform treatment of the surface.

FIG. 6 shows a device in which the discharge is produced by an alternating current generated by a power supply circuit according to FIG. 7b and is urged against the surface to be treated by means of a magnetic field, which is constant. The discharge, when viewed in the plane of the surface to be treated 19, bears resemblance with a butterfly with its wings spread out. The electric power produced in the discharge is distributed over the entire treatment surface. This makes it possible to carry out the treatment of sensitive surfaces with a sweeping motion, which ensures that no localised burns occur. One can obtain the same sort of sweeping discharge by using a direct current and an alternating magnetic field.

FIGS. 7a to 7e illustrate different power supply circuits 12 of different devices for carrying out the method of the present invention as well as the oscillograms of the current I of the discharge as a function of time t. The circuit 12a of FIG. 7a corresponds to a power supply with a direct current of a high voltage. The discharge is produced as a high voltage direct current. The discharge occurs upon the breakdown in the gap between the electrodes when the voltage across the terminals of the capacitor C is sufficiently high and after a certain time of relaxation, the current stabilises. This power supply circuit can be used in the case of the devices of FIGS. 3, 13 and 14.

The circuit 12b of FIG. 7b ensures the supply of a high voltage alternating current. The discharge is initiated periodically and ends after each half-period of the current. The frequency of the process can be varied and controlled by means of the device F. The periodical variations of the current are accompanied with oscillations of a sonic or of an ultrasonic frequency in the plasma. This has an influence on the nature of the treatment, for example of biological tissues. This power supply circuit can be used in the devices illustrated in FIGS. 3, 7, 13 and 14 and is the only one possible in the case of the device according to FIG. 6.

The circuit 12c of FIG. 7c corresponds to a power supply with a high voltage three-phase current (see embodiment of FIG. 4). In this power supply circuit, the discharge in the gap between the electrodes never disappears altogether, even though it actually disappears periodically between different pairs of electrodes. This ensures the stability of the discharge, in particular when the flow rate of the carrier gas is high. This circuit makes it possible to produce the discharge at a lower tension than in the case of a monophase current supply.

The supply circuit 12d of FIG. 7d corresponds to a three-phase power supply from a device including electrically independent coils. This circuit can be used for the supply of a device including a large number of electrodes, amounting to a multiple of 3 (such as in the embodiment of FIG. 5).

The supply circuit 12e makes it possible to feed the device with pulses. This circuit makes it possible to ensure an intense treatment, for example, of biological tissues, carried out in short periods with long interruptions therebetween. This makes it possible, amongst others, to carry out surface treatments without exposing these surfaces to a high (average) flow of heat. One can adjust the discharge parameters, such as the time elapsed between the pulses, their intensity and the slope of their leading edge.

The duration of the pulses is adjusted by the magnitude of the resistance of the resistor Ra, which determines the duration of the charging of the capacitor C up to the breakdown voltage. The intensity of the pulses is determined by the capacitance of the capacitor C. The energy of the pulse, w, amounts to:
w=CU²/2
in which U is the voltage across the terminals of the capacitor. The slope of the leading edge is determined by the inductance L connected consecutively to the discharge.

In the power supply circuits 12a, 12b, 12c and 12d, inductive resistances are used which make it possible to limit the flow of active power and to facilitate the stabilisation of the discharge.

FIG. 8 illustrates an embodiment in which the tubular electrodes 4a, 4b are made of a dielectric material and are surrounded by coaxial tubes 35 (made of a conductive material, for example of a metal), which are power supplied from a source of high frequency current and which are cooled by a gas Q₃, injected into a space between the coaxial tubes, in the direction of the plasma zone 16.

FIG. 9 illustrates an embodiment of the invention in which the tubular electrodes 4a, 4b are constructed as converging cones, which makes it possible to increase the velocity of the plasma jets 14a, 14b and to better define the treatment discharge zone 16 on the surface to be treated.

FIG. 10. illustrates an embodiment of the invention in which the tubular electrodes 4a, 4b are provided with rings 38, which are made of a metal with a high thermal conductivity (for example Cu) and which make it possible, as illustrated in FIG. 11a by the isotherms 39a in the wall of the electrode, to increase the cooling zone 40 of the electrodes by comparison with an electrode wall 41 without any ring, as illustrated by the isotherms 39a of FIG. 11b. The ring 38 ensures a better cooling, while using a material with a high fusion temperature (for example tungsten W) enabling the electrode to operate under conditions of high heat production.

FIG. 12 illustrates an embodiment of the present invention in which the tubular electrodes 4a, 4b have flow channels for the carrier gas Q₁ in the form of supersonic nozzles (Laval nozzles). This version is advantageous, in that it makes it possible to project the plasma on the surface with a high hydrodynamic force and to take advantage of the shock wave 43 which forms above the surface to be treated 10, and which regenerates the plasma 16 upon contact with the surface to be treated.

FIG. 15 is a photograph of the discharge generated between two tubular electrodes by a device similar to that illustrated in FIG. 3a. This photograph illustrates the spike-shaped form of the plasma channel created by the competition of the hydrodynamic forces and of Ampere's forces, on the one hand, with the electro-dynamic forces ensuring the discharge, on the other hand.

FIGS. 16a to 16d are photographs of discharges similar to that of FIG. 15 and they illustrate different possible shapes of the discharge between the tubular electrodes. Depending on the magnitude of the flow rate of the gas fed to the tubular electrodes, the magnitude of the current and of its voltage, one can achieve a discharge between the two channels exiting from the tubular electrodes which is diffuse, as is illustrated in FIG. 16a, or a breakdown discharge between the channels as illustrated in FIG. 16b or further combinations of these two types, as illustrated in FIGS. 16c and 16d.

Another version of the present invention is illustrated in FIG. 13. In this device, the inner electrode 4, constructed as a thin tube and the outer electrode 104, constructed as a hollow truncated cone, are arranged coaxially. The carrier gas Q₁ is introduced via a channel 6 in the inner electrode and an additional gas Q₃ can also be introduced via the channels 24, arranged symmetrically with respect to the central electrode. In such a construction, the plasma has the shape of a narrow dart which makes it possible to carry out a point treatment, for example on a biological tissue.

FIG. 14 represents a device for implementing the present invention in which one of the electrodes 204 is constructed as a monolithic rod made of a refractory material (for example tungsten) of which the end is located on the tangent to the stream of carrier gas, emitted from a tubular electrode 4. Such a construction makes it possible to create a discharge with a device having a minimal outer diameter, useful in coelioscopy, for instance.

### EXAMPLE 1

Activation of a Plastic Material

Material treated: polyethylene
   polypropylene
   polyethylene terephthalate
Source of current: U=1000 V, I=100 mA
Carrier gas: Kr (20%)+O₂ (80%)
Treatment in ambient air
Calculation of the surface energy W_{surface}
   W_{surface}=C_{water}(1+cos θ)
   C_{water}=71.2 mJ/m²
   θ—contact angle, degrees

The contact angles θ are measured with an apparatus of the Digidrop type, model CA-S-150.

TABLE 1
Influence of the duration of the treatment on the surface
energy of different plastic materials

| | Du- | Surface energy 10⁻³ J/m² | | |
|---|---|---|---|---|
| | ration | (flow rate of the carrier gas = 30 l/min) | | |
| N° | (sec) | Polyethylene | Polypropylene | Polyethylene terephthalate |
| 1 | 0 | 77.3 | 81.2 | 82.5 |
| 2 | 3 | 118.9 | 129.7 | 142.1 |
| 3 | 5 | 124.3 | 131.8 | 142.5 |
| 4 | 10 | 135.1 | 137.7 | 142.7 |
| 5 | 15 | 139.7 | 140.1 | 142.5 |
| 6 | 20 | 139.4 | 139.6 | 142.6 |
| 7 | 25 | 138.7 | 139.1 | 142.3 |
| 8 | 40 | 131.1 | 122.5 | 142.1 |

The above results indicate that the activation of plastic material reaches a very high level after a treatment of about 5 seconds, with all the plastic materials investigated. The results of table 1 are illustrated graphically in FIG. 17a.

### EXAMPLE 2

Activation of a Plastic Material Before its Painting

Material treated: polypropylene
Source of current: U=100 V, I=100 mA
Carrier gas: Xe (10%)+O₂ (90%)
Treatment in ambient air
Paint: glossy, applied from an aerosol can

The measurement of the adhesion of the paint to the plastic material was carried out using a standard method (standard 50488/01).

TABLE 2
influence of the duration of the treatment on the contact angle, the surface
energy and the adhesion to the plastic material.

| | | | Duration | Diameter of | | | |
|---|---|---|---|---|---|---|---|
| | | Flow rate of the | of the | the drop on | Contact | Surface | |
| | | carrier gas | treatment | the surface | angle | energy | |
| N° | Gas | (1/min) | (sec) | (mm) | (degrees) | (mJ/m²) | Adhesion |
| 1 | O₂ | 30 | 0 | 3 | 93 | 67.6 | >Ad 5 |
| 2 | O₂ | 30 | 3 | 5 | 37 | 128.2 | Ad 2 |
| 3 | O₂ | 30 | 5 | 6 | 25 | 136.1 | Ad 1 |
| 4 | O₂ | 30 | 10 | 8 | 17 | 139.6 | Ad 0 |
| 5 | O₂ | 30 | 15 | 11 | 13 | 140.5 | Ad 0 |
| 6 | O₂ | 30 | 20 | 15 | 10 | 141.3 | Ad 0 |
| 7 | O₂ | 30 | 25 | 10 | 15 | 139.8 | Ad 0 |
| 8 | O₂ | 30 | 40 | 7 | 28 | 133.8 | Ad 2 |

The above results indicate that the activation ensures a high level of adhesion. The results of table 2 are illustrated graphically in FIG. 17b.

### EXAMPLE 3

Activation of a Plastic Material Using Different Carrier Gases

Material treated: polypropylene
Gas: Ar (20%)+(Ar, N₂, O₂, CO₂ or air) (80%)
Source of current: U=100 V, I=100 mA

Treatment in ambient air

TABLE 3
influence of the duration of the treatment on the surface energy of a
plastic material, using different carrier gases.

| | | Surface energy, 10⁻³ J/m² | | | | |
|---|---|---|---|---|---|---|
| | | (polypropylene, | | | | |
| | Duration | gas flow rate = 30 l/min) | | | | |
| N° | (sec) | N₂ | Ar | CO₂ | O₂ | Air |
| 1 | 0 | 73.7 | 73.7 | 73.7 | 73.7 | 73.7 |
| 2 | 3 | 105.1 | 93.4 | 105.7 | 129.8 | 122.8 |
| 3 | 5 | 121.1 | 106.8 | 118.9 | 135.2 | 127.6 |
| 4 | 10 | 122.9 | 113.9 | 130.3 | 140.3 | 131.9 |
| 5 | 15 | 119.2 | 122.2 | 130.3 | 141.3 | 125.5 |
| 6 | 20 | 107.7 | 123.2 | 129.5 | 141.1 | 123.3 |
| 7 | 30 | 101.3 | 119.8 | 130.2 | 141.7 | 114.3 |

The results of Table 3 are illustrated graphically in FIG. 17c.

TABLE 4
influence of the flow rate of the gas on the surface energy of a
plastic material treated with different carrier gases.

| | |
|---|---|
| | Surface energy, 10⁻³ J/m² |
| Flow rate of the | (duration of the treatment = 10 sec) |

| No | gas G/t (l/min) | Ar | CO₂ | O₂ |
|---|---|---|---|---|
| 1 | 0 | 73.7 | 73.7 | 73.7 |
| 2 | 5 | 112.3 | 138.3 | 101.1 |
| 3 | 10 | 127.3 | 139.1 | 122.4 |
| 4 | 15 | 122.2 | 137.5 | 125.5 |
| 5 | 20 | 117.9 | 136.2 | 138.8 |
| 6 | 25 | 114.5 | 131.9 | 138.8 |
| 7 | 30 | 112.1 | 130.2 | 140.5 |

The above results indicate that different carrier gases can be used for surface activation. The best results were achieved with oxygen. The results of table 4 are illustrated graphically in FIG. 17d.

### EXAMPLE 4

### Modification of the Surface of a Cloth

Material treated: cloth (polyester) with a specific weight of 820 g/m²
Source of current: U=1000 V, I=100 mA
Carrier gas: Ar (10%)+oxygen (90%)

The activation is measured by determining the speed of rise of water (calculated as the ratio of the height to the duration of the rise) in samples placed vertically.

TABLE 5
Influence of the duration of the treatment on the speed of rise of water

| | | Height of the rise (mm) | | | |
|---|---|---|---|---|---|
| | Duration | Duration of | Duration of | Duration of | Duration of |
| | of the rise | treatment: | treatment: | treatment: | treatment: |
| N° | (sec) | 0 s | 3 s | 5 s | 10 s |
| 1 | 0 | 0 | 0 | 0 | 0 |
| 2 | 5 | 0.5 | 5.1 | 10.2 | 21.3 |
| 3 | 10 | 1.4 | 11.2 | 17.5 | 31.2 |
| 4 | 20 | 2.3 | 18.3 | 24.4 | 37.5 |
| 5 | 30 | 3.2 | 23.2 | 30.3 | 42.4 |
| 6 | 40 | 4.1 | 25.4 | 32.5 | 44.1 |
| 7 | 50 | 5.2 | 28.7 | 34.7 | 46.8 |

One can see that the modification of the surface increases significantly the speed of rise of the water. Improved hydrophilic properties contribute to improving impregnation. The results of table 5 are illustrated graphically in FIG. 17e.

### EXAMPLE 5

### Sterilisation of Samples Contaminated by Different Types of Micro-Organisms

Container: plastic material—polypropylene
Source of current: U=1000 V, I=100 mA
Gas: Ar (10%)+air (90%)
Micro-organisms: Aspergillus niger ATCC 16404
   Byssochlamys nivea 1910-90

The counting of the number of surviving micro-organisms was carried out using methods conventionally practised in the field of microbiology.

TABLE 6
influence of the flow rate of the gas on the number
of surviving micro-organisms.

| | | | Number of surviving micro-organisms | |
|---|---|---|---|---|
| | Flow rate | | Aspergillus niger | Byssochlamys nivea |
| N° | (l/min) | Initial | ATCC 16404 | 1910-90 |
| 1 | 0 | 320 | — | — |
| 2 | 5 | 320 | 0 | 0 |
| 3 | 7.5 | 320 | 0 | 6 |
| 4 | 10 | 320 | 6 | 45 |
| 5 | 20 | 320 | 58 | 113 |
| 6 | 30 | 320 | 93 | 171 |
| 7 | 40 | 320 | 126 | 231 |
| 8 | 50 | 320 | 171 | 273 |
| 9 | 60 | 320 | 221 | 287 |
| 10 | 70 | 320 | 265 | 298 |

One can see that the sterilisation of the surface of the sample is complete at flow rates of the gas between 5 and 7.5 l/min. This flow rate depends on the type of micro-organism present. The results of table 6 are illustrated graphically in FIG. 17f.

### EXAMPLE 6

### Modification of a Ceramic Material and Polymerisation of a Film on the Surface of Samples

Material treated: a ceramic material (for example a tile)
Source of current: U=1000 V, I=100 mA
Modifier gas: Ar (20%)+(O₂, O₂+CF₄, air) (80%)
Polymerisation gas: Ar (30%)+C₃F₆ (70%)
Liquid used for measuring the contact angle: water, oil, petrol

The contact angles were measured with an apparatus of the Digidrop type, model CA-S-150

TABLE 7
influence of the activation and of the polymerisation on the contact angle

| | | | | | Contact angle | | |
|---|---|---|---|---|---|---|---|
| | Activation | | Polymerisation | | (degrees) | | |
| N° | Gas | Duration (sec) | Gas | Duration (sec) | Water | Oil | Petrol |
| 1 | — | — | — | — | 55 | 43 | 44 |
| 2 | O₂ | 30 | — | — | 57 | 47 | 42 |
| 3 | O₂ + CF₄ | 30 | — | — | 58 | 11 | 8 |
| 4 | Air | 30 | — | — | 7 | 6 | 0 |
| 5 | — | — | Ar + C₃F₆ | 300 | 149 | 111 | 85 |
| 6 | O₂ | 30 | Ar + C₃F₆ | 180 | 159 | 151 | 71 |
| 7 | O₂ + CF₄ | 30 | Ar + C₃F₆ | 180 | 144 | 136 | 80 |
| 8 | Air | 30 | Ar + C₃F₆ | 180 | 149 | 142 | 90 |
| 9 | Air | 30 | Ar + C₃F₆ | 300 | 149 | 142 | 93 |

The above results indicate that the polymerisation makes it possible to obtain a hydrophobic film on the surface of a ceramic sample. The surface modification before the polymerisation improves the results of the polymerisation.

### EXAMPLE 7

### Surface Modification and Polymerisation of a Film on the Surface of Samples

Material treated: polyester cloth (specific weight: 450 g/m²)
Source of current: U=1000 V, I=100 mA
Modifier gas: Ar (10%)+O₂ (90%)
Polymerisation gas: Ar (30%)+C₃F₆ (70%)
Liquid for measuring the contact angle: water

The contact angles were measured with the apparatus of the Digidrop type, model CA-S-150

TABLE 8
Influence of the activation and of the polymerisation on the contact angle

| | | Contact angle | | Surface energy | |
|---|---|---|---|---|---|
| | | (degrees) | | (mJ/m²) | |
| | Duration of the | Without | With | Without | With |
| N° | Polymerisation (sec) | activation | activation | activation | activation |
| 1 | 0 | 3 | 3 | 142.3 | 142.3 |
| 2 | 30 | 23 | 34 | 136.8 | 130.2 |
| 3 | 60 | 52 | 75 | 115.1 | 89.7 |
| 4 | 90 | 78 | 101 | 85.9 | 57.7 |
| 5 | 120 | 93 | 114 | 67.5 | 42.2 |
| 6 | 150 | 99 | 127 | 60.1 | 28.3 |
| 7 | 180 | 101 | 131 | 57.7 | 24.5 |
| 8 | 300 | 100 | 129 | 57.9 | 26.4 |

The above results indicate that the polymerisation makes it possible to obtain a cloth with hydrophobic properties. The activation carried out before the polymerisation improves the hydrophobic properties. The results of table 8 are illustrated graphically in FIGS. 17g and 17h.

In all the examples mentioned, a plasma generator was used, of which the main elements were tubular electrodes fed with a carrier gas mixture having an ionisation potential and the ionisation enthalpy lower than those of the ambient gas (ambient air).

### EXAMPLE 8

### The Device Used in this Example is the Device Shown in the Photographs of FIGS. 15 and 16, corresponding essentially to the embodiment of FIG. 3a, However with parallel tubular electrodes

The carrier gas is, in this particular case, krypton. The plasma device functions in ambient air. One can clearly see in the photographs of FIGS. 15 and 16 the two tubular electrodes, here running parallel to each other. From these electrodes, bright parallel plasma jets are projected. The space between these jets, significantly darker, corresponds to the zone through which travel the electrons and in which the plasma is out of thermodynamic and chemical equilibrium. The electrons have a very high energy and their average travel distance is high, of up to several millimetres. It is only in the zone of the jets that they transfer their kinetic energy as excitation energy to the gas issued from the jets. The two visible plasma channels are formed by the stream of electrons ionising the carrier gas emitted from the tubular electrodes, this gas having an ionisation energy lower than that of the ambient gas (air in this case).

The two plasma jets constitute actually two plasma electrodes between which the electric discharge takes place. The latter can be a diffuse discharge, a non autonomous discharge or a breakdown accompanied by the formation of localised filaments in the plasma, depending on the flow rate of the carrier gas in the tubular electrodes and on the voltage between the electrodes.

### EXAMPLE 9

### Use of a Device for the Treatment of Surfaces According to the Invention, in Surgical Operations

1. Cauterisation of blood effusion
2. Stopping the oozing of blood plasma from burns
   1. Cauterisation of Blood Effusion

Surgical operations were carried out on pigs. The device used included a plasma generator with two tubular electrodes as in the example 8 above, through which were introduced gases (Ar, Kr, Xe) of which the energy of ionisation (enthalpy of ionisation) was lower than that of the ambient air. In the zone of treatment, gases such as O₂, CO₂, N₂ were introduced via an intermediate nozzle. The frequency of the generator was 300 kHz. The magnitude of the voltage was 300 V. The flow rate of the gas introduced via the tubular electrodes was in the range from 0.1 l/min to 2 l/min. The flow rate of the additional gas was in the range from 0.2 l/min to 3 l/min.

The operations were carried out either on tissues exposed to ambient air or by coelioscopy. In the latter case, the apparatus containing the plasma generator was equipped with a tube with an automatic pressure adjustment means to prevent the pressure within the operating chamber to increase during the use of the plasma generator. The purpose here was to test the cauterisation capacity of the device described. To this end, important haemorrhages were created in the skin, in muscles, in the diaphragm, in the liver, in the spleen, in the intestine, in the gallbladder, in the bladder, in the internal genital organs, in blood vessels (veins and even small arteries), in the lungs and in the heart. In all cases, the apparatus has enabled a cauterisation of the haemorrhages, which was rapid and efficient.

The histological studies carried out after the operations have shown that the damages caused to the tissues treated were much less important than in the case of a cauterising apparatus provided with one electrode (of the Erbotom 12C350 type) which was used at the same time as the apparatus of the present invention, for comparative purposes. This result was due to the absence of the destructive passage of electric current through the wound and the patient.

2. Stopping the Oozing of Blood Plasma from Burns

The operations were carried out on pigs, which had been subjected to third degree burns on their backs. The use of the above-mentioned apparatus under the same conditions as above, has made its possible to cauterise infiltrations (oozing) of blood plasma, which are characteristic of this type of burn.

The burnt zones were rapidly dried and healed. No infection was reported, even though the burn wounds had not been specially protected from contaminations. This indicates that the treatment of the burn by the plasma generator with two tubular electrodes is not only a cauterising treatment, but, additionally, a sterilising treatment.

A “caramelising” treatment was also carried out on third degree burns. Here, the additional gas used was a mixture of argon, of hexamethyldisilazane and of oxygen.

The burnt zone was first dried by an argon+oxygen plasma and was subsequently covered with a thin crust (˜0.1 μm) of silicon oxide, which functioned as a protection impervious to external contaminating elements. As this layer was very thin, it caused subsequently no damage and disappeared without any residue, leaving a clean scar, which also disappeared rapidly.

1-37. (canceled)

38. Method of treating a surface by atmospheric plasma, including the generation of at least one plasma jet using a plasma generator, the plasma jet being created by an electric discharge in a stream of a carrier gas or of a carrier gas mixture having an ionisation enthalpy lower than that of the ambient gaseous medium, wherein a zone of electric discharge located between said plasma jet which functions as an electrode, and a second electrode or plasma jet functioning as an electrode, is non-autonomous and generates a plasma comprised mainly of an activated gas used for treating the surface, the intensity E of the electric field creating the discharge satisfying the condition:
(JnQ/e)_{carrier gas}≦E≦(JnQ/e)_{ambient gas}
in which J is the energy of activation of the gas particles,
n is the density of the particles of this gas,
Q is the effective cross-section of the elastic collisions of the electrons with the particles of this gas, and
e is the charge of an electron.

39. Method according to claim 38, wherein at least two plasma jets, which function as electrodes, are generated by using plasma generators.

40. Method according to claim 39, wherein the plasma jets are generated from tubular electrodes having channels into which the carrier gas is injected.

41. Method according to claim 39, wherein electric breakdowns are generated between the plasma jets.

42. Method according to claim 39, wherein a magnetic field directed substantially perpendicularly to the surface to be treated is applied by the plasma in order to broaden the zone of action of the plasma on the surface to be treated.

43. Method according to claim 39, wherein the plasma jets are directed adjustably to create a treatment zone which is either confined or broad, whereby the plasma is urged against the surface to be treated simultaneously by inertial hydrodynamic forces and by Ampere's forces.

44. Method according to claim 40, wherein the axes of the tubular electrodes are parallel to each other.

45. Method according to claim 38, wherein at least one plasma jet is generated by a plasma generator comprising a tubular electrode having a channel into which a carrier gas is injected and a second electrode.

46. Method according to claim 38, wherein the plasma for treating the surface is formed in a gas or in a gaseous mixture Q2, Q3, which differs from the carrier gas or the carrier gas mixture Q1.

47. Method according to claim 38, wherein the plasma is generated by unipolar or bipolar electric pulses, wherein the duration of the leading edge of the pulses, the duration of the pulses and the time elapsed between the pulses are adjusted.

48. Device for the treatment of a surface by atmospheric plasma including at least two electrodes, at least one of the electrodes provided as a tube forming a central flow channel for a carrier gas supplied from a carrier gas supply system, said at least two electrodes being connected to a power supply circuit adapted to control an electric field creating a discharge having an intensity E satisfying the condition:
(JnQ/e)_{carrier gas}≦E≦(JnQ/e)_{ambient gas}
in which J is the energy of activation of the gas particles,
n is the density of the particles of this gas,
Q is the effective cross-section of the elastic collisions of the electrons with the particles of this gas, and
e is the charge of an electron.

49. Device for the treatment of a surface by atmospheric plasma including a power supply circuit and at least two tubular electrodes having axes intersecting at an angle in the range from 0° to 180°, the tubular electrodes connected to said power supply circuit, the power supply circuit adapted to control an electric field creating a discharge having an intensity E satisfying the condition:
(JnQ/e) carrier gas≦E≦(JnQ/e) ambient gas
in which J is the energy of activation of the gas particles,
n is the density of the particles of this gas,
Q is the effective section of the elastic collisions of the electrons with the particles of this gas, and
e is the charge of an electron.

50. Device according to claim 49, wherein the tubular electrodes are positioned with respect to each other such that a point of intersection of the axes of the tubular electrodes is located beneath the surface to be treated.

51. Device according to claim 49, wherein one or several of the gas streams are directed from cylindrical or flattened nozzles, positioned between the tubular electrodes and directed towards the surface to be treated, in such a manner as to modify the composition of activated gas of said plasma impinging upon the surface to be treated.

52. Device according to claim 49, wherein a plurality of pairs of tubular electrodes is arranged substantially along a line in the manner of a comb, to enable sweeping a broad surface of the object to be treated with plasma.

53. Device according to one of the preceding claims, including means for adjusting the angles between the electrodes and the distance between the electrodes.

54. Device according claim 49, including means for adjusting the flow rate of the gas introduced via the tubular electrodes, the flow rate of the gases introduced between plasma jets generated by the tubular electrodes, the magnitude of electrical current and voltage between the electrodes.

55. Device according to claim 49, including means for adjusting the distance of the electrodes to the surface of the material to be treated.

56. Device according to claim 49, wherein the tubular electrodes are positioned in such that their axes are parallel to each other.

57. Device according to claim 49, including a system of longitudinal tubes provided in a honeycomb arrangement, the tubes having different lengths in order to confer a specific profile to the distribution of the flow velocity of the carrier gas, and to avoid turbulence in the stream of the plasma emitted from the electrodes.

58. Device according to claim 49, including a nozzle with radial perforations, provided between the electrodes in order to ensure that the streams of the gas injected between the tubular electrodes are directed radially as well as in the direction of plasma jets generated by the tubular electrodes.

59. Device according to claim 49, including three said tubular electrodes, supplied from a three-phase power supply source, the carrier gas being supplied via a coaxial tube equidistant from the three tubular electrodes.

60. Device according to claim 49, comprising a cooled magnetic field generator positioned between the electrodes to create a magnetic field perpendicular to the surface to be treated.

61. Device according to claim 48 or 49, wherein the power supply circuit for producing the electric discharge is adapted to generate pulses, of which the leading edge, the duration and the frequency are controllable.

62. Device according to claim 48 or 49, wherein the tubular electrodes comprise dielectric tubes surrounded by coaxial metal tubes.

63. Device according to claim 48 or 49, wherein the tubular electrodes have a conical shape to focus the streams of the carrier gas on the zone to be treated.

64. Device according to claim 48 or 49, wherein the tubular electrodes are cooled externally and are equipped internally with tubular rings, in such a manner as to dissipate the heat produced by electrode spots.

65. Device according to claim 48 or 49, wherein the tubular electrodes comprise supersonic nozzles or Laval nozzles in order to increase the hydrodynamic forces urging the plasma against the surface to be treated, by creating a shock wave above the surface to be treated.

66. Device according to claim 48, wherein the second electrode is in the form of a hollow truncated cone arranged coaxially around the tubular electrode.

67. Device according to claim 48, wherein the second electrode is in the form of a rod.

68. Use of a device according to claim 48 or 49, for the treatment of textile materials, in order to confer thereto hydrophilic or hydrophobic properties.

69. Use of a device according to claim 48 or 49, for the treatment of ceramic materials, in order to confer thereto hydrophilic or hydrophobic properties.

70. Use of a device according to claims 48 or 49, for the cauterisation of blood and of medico-biological tissues during surgical operations.

71. Use of a device according to claims 48 or 49, for stopping the oozing of lymphatic liquid from burns.

72. Use of a device according to claims 47 or 48, for the activation of the surface of metal objects, of weakly conductive objects and of dielectric objects, in order to increase their adhesivity to paints, to adhesives or to other substances.
